(19) United States
(12) Patent Application Publication
(10) Pub. No.: US 2020/0282414 A1
(43) Pub. Date: Sep. 10, 2020

(54) AUTOMATIC SAUCE DISPENSING SYSTEM

(71) Applicant: A. J. ANTUNES & CO., CAROL STREAM, IL (US)

(72) Inventors: Steve Gauger, Crystal Lake, IL (US); Margaret Naden, West Dundee, IL (US); David Anchor, Union, IL (US); Chad Elliott, Frankfort, IL (US)

(21) Appl. No.: 16/812,326

(22) Filed: Mar. 8, 2020

Related U.S. Application Data
(60) Provisional application No. 62/816,090, filed on Mar. 9, 2019.

(51) Int. Cl. B05B 9/04; A47F 10/06; G06Q 20/20; B05B 12/08; B05B 15/55

(52) U.S. Cl. CPC B05B 9/0423; A47F 10/06; B05B 15/55; B05B 12/081; G06Q 20/20

(57) ABSTRACT

A new and improved automatic sauce dispensing system, which is to be utilized in restaurants, particularly fast-food restaurants, in order to quickly and accurately prepare food products, such as, for example, conventional hamburger sandwiches which require two buns, or Big Mac® sandwiches which require three buns, or other food items which desire or require to have specific sauces deposited thereon in accordance with specific patron orders, is disclosed. A plurality of sauce containers are fluidically connected to a plurality of sauce dispensing valves which are capable of being moved in a direction perpendicular to the direction of travel of food products along a food product conveyor. The dispensing valves are therefore capable of being located at any xy coordinate relative to the food product conveyor so as to accurately dispense and deposit a particular sauce onto a food product.

### REFERENCE TO CORRESPONDING APPLICATION

This United States Non-Provisional patent application is a Non-Provisional Conversion of U.S. Provisional Patent Application No. 62/816,090 which was filed on Mar. 9, 2019, the priority benefits of which are hereby claimed.

The present invention relates generally to food service equipment, and more particularly to a new and improved automatic sauce dispensing system which is to be utilized in restaurants, particularly fast-food restaurants, in order to quickly and accurately prepare food products, such as, for example, conventional hamburger sandwiches which require two buns, or Big Mac® sandwiches which require three buns, or other food items which desire or require to have specific sauces deposited thereon in accordance with specific patron orders.

### BACKGROUND OF THE INVENTION

Conventionally, when preparing specific food orders, particularly in a fast-food restaurant, and more particularly, in connection with hamburgers, Big Macs®, Whoppers®, nachos, or the like, food preparation personnel must, for example, utilize conventional hand-held sauce dispensing containers. Obviously, the use of such conventional hand-held sauce dispensing containers is cumbersome and time-consuming in that the food preparation personnel must grip or grasp the hand-held sauce dispensing container, apply what he or she determines to be the proper amount of sauce to be dispensed onto the food item, replace the conventional hand-held sauce dispensing container to its storage place after the food preparation person has in fact dispensed the sauce or condiment onto the food item, and then the basic food preparation process is repeated in connection with subsequent food items to be prepared in a similar manner by dispensing particular sauces or condiments onto the food items. This process is obviously somewhat tedious and is further exacerbated when different sauces or condiments are to be deposited onto different, or even the same, food item(s). For example, let us assume that a patron has placed an order for a Big Mac® and in addition to the special sauce for which the Big Mac® is known, the patron also wants mustard and ketchup on the Big Mac®. Therefore, the food preparation personnel must utilize three different sauce or condiments dispensers respectively containing the special sauce, the mustard, and the ketchup. Obviously, such food preparation procedures are very inefficient, time consuming, and labor intensive, particularly for fast-food restaurants wherein quick or rapid cooking or toasting food preparation times are required or desirable in order to produce the finalized food items within relatively short service times which effectively define one of the more important and attractive features or characteristics of fast-food establishments.

A need therefore exists in the art for a new and improved piece of food service equipment. An additional need exists in the art for a new and improved piece of food service equipment which is adapted to prepare specific food items. A still additional need exists in the art for a new and improved piece of food service equipment which is adapted to prepare specific food items, such as, for example, hamburgers, Big Macs®, Whoppers®, or the like. A yet additional need exists in the art for a new and improved piece of food service equipment which can be utilized in various different food establishments. A still yet additional need exists in the art for a new and improved piece of food service equipment which can be utilized in various different food establishments, such as, for example, fast food restaurants. A further need exists in the art for a new and improved piece of food service equipment which can be utilized in various different food establishments, such as, for example, fast food restaurants, wherein quick turnaround time for preparing food item orders is a highly sought-after feature or characteristic. A still further need exists in the art for a new and piece of improved food service equipment which can be utilized in various different food establishments, such as, for example, fast food restaurants, wherein the equipment is very efficient in connection with the preparation of specific food items ordered by patrons at the point-of-sale (POS) location.

A yet further need exists in the art for a new and improved piece of food service equipment which can be utilized in various different food establishments, such as, for example, fast food restaurants, wherein the appliance is very efficient in connection with the preparation of the food items or products, and can be operated by means of a minimum number of food preparation personnel. A still yet further need exists in the art for a new and improved piece of food service equipment which can be utilized in various different food establishments, such as, for example, fast food restaurants, wherein the equipment is very efficient in connection with the preparation of the food items or products, can be easily operated by means of a minimum number of food preparation personnel, and can be utilized to prepare numerous food items in an automatic, serial manner as opposed to the food items being singly prepared in a one-by-one fashion. A yet still further need exists in the art for a new and improved piece of food service equipment which can be utilized in various different food establishments, such as, for example, fast food restaurants, wherein numerous sauce or condiment containers can effectively be pre-loaded into the equipment, particularly during lull or relatively slow business hours or times, such that the plurality of food items will then be able to be substantially immediately prepared as orders are inputted into the system for patrons at the point-of-sale (POS) location as opposed to being constrained to being processed in a single or one-by-one fashion.

### OVERALL OBJECTIVES OF THE PRESENT INVENTION

A primary objective of the present invention is to therefore provide a new and improved piece of food service equipment. An additional objective of the present invention is to therefore provide a new and improved piece of food service equipment which is adapted to prepare specific food items. A still additional objective of the present invention is to therefore provide a new and improved piece of food service equipment which is adapted to prepare specific food items, such as, for example, hamburgers, Big Macs®, Whoppers®, or the like. A yet additional objective of the present invention is to therefore provide a new and improved piece of food service equipment which can be utilized in various different food establishments. A still yet additional objective of the present invention is to therefore provide a new and improved piece of food service equipment which can be utilized in various different food establishments, such as, for example, fast food restaurants. A further objective of the present invention is to therefore provide a new and improved piece of food service equipment which can be utilized in various different food establishments, such as, for example, fast food restaurants, wherein quick turnaround time for preparing food item orders is a highly sought-after feature or characteristic. A still further objective of the present invention is to therefore provide a new and piece of improved food service equipment which can be utilized in various different food establishments, such as, for example, fast food restaurants, wherein the equipment is very efficient in connection with the preparation of specific food items ordered by patrons at the point-of-sale (POS) location.

A yet further objective of the present invention is to therefore provide a new and improved piece of food service equipment which can be utilized in various different food establishments, such as, for example, fast food restaurants, wherein the appliance is very efficient in connection with the preparation of the food items or products, and can be operated by means of a minimum number of food preparation personnel. A still yet further objective of the present invention is to therefore provide a new and improved piece of food service equipment which can be utilized in various different food establishments, such as, for example, fast food restaurants, wherein the equipment is very efficient in connection with the preparation of the food items or products, can be easily operated by means of a minimum number of food preparation personnel, and can be utilized to prepare numerous food items in an automatic, serial manner as opposed to the food items being singly prepared in a one-by-one fashion. A yet still further objective of the present invention is to therefore provide a new and improved piece of food service equipment which can be utilized in various different food establishments, such as, for example, fast food restaurants, wherein numerous sauce or condiment containers can effectively be pre-loaded into the equipment, particularly during lull or relatively slow business hours or times, such that the plurality of food items will then be able to be substantially immediately prepared as orders are inputted into the system for patrons at the point-of-sale (POS) location as opposed to being constrained to being processed in a single or one-by-one fashion.

### SUMMARY OF THE INVENTION

The foregoing and other objectives are achieved in accordance with the teachings and principles of the present invention through the provision of a new and improved automatic sauce dispensing system wherein a plurality of vertically oriented sauce dispensing canisters, having sauce dispensing containers removably disposed therein, are fixedly mounted in a side-by-side manner upon a vertically oriented mounting plate which is, in turn, fixedly mounted upon an automatic sauce dispensing framework. The canister/sauce container assemblies can be pivotally mounted upon the framework by means of a bracket assembly which is controlled by means of a suitable actuator, such that the actuator can effectively move the canister/sauce container assemblies between upper dispensing positions and lower refill or exchange positions by means of which depleted sauce containers can be replaced with fresh sauce containers containing full supplies of a particular sauce.

Level sensors are respectively employed with each canister/sauce container assembly and comprise a light beam transmitter which can, for example, send a light beam through the canister/sauce container assembly, while a light beam receiver, disposed diametrically opposite the light beam transmitter, will receive the light signal. When a sauce container is depleted, or, alternatively, when the sauce remaining within the sauce container reaches a predeterminedly low level, the light beam from the sensor transmitter will be received by the sensor receiver indicating that the particular sauce container has been depleted, or is about to become depleted, whereby food preparation personnel can then remove the depleted or near depleted container and replace the same with a new container containing a full supply of the particular sauce. It is to be noted that the light sensing system is attuned or calibrated in such a manner that the sensor system can determine the difference between a sufficient supply of sauce remaining within the sauce container and a film of sauce which may remain upon interior peripheral wall portions of the sauce container as the sauce container becomes depleted.

It is further noted that the number of individual canister/sauce container assemblies may be, for example, seven, although a fewer or greater number of canister/sauce container assemblies may be employed depending upon the particular needs of the particular food establishment. The upper end of each canister/sauce container assembly is fitted with a removable canister cap, and the lower end of each canister/sauce container assembly is provided with a quick disconnect fitting. By removing the upper removable canister caps and the lower quick disconnect fittings, depleted sauce containers can be removed and new sauce containers, containing fresh supplies of particular sauces, may be inserted into the canisters. In addition, the removable canister caps contain fittings which are adapted to be fluidically connected to a source of air which is used to supply incoming air into the top of each canister/container assembly and thereby pressurize the particular sauce, contained within the particular sauce container, such that the sauce will flow downwardly and outwardly through means of the quick disconnect fitting. In turn, the quick disconnect fittings, which are fixedly connected to the lower ends of the canister/sauce container assemblies, are respectively fluidically connected to a plurality of valve banks by means of flexible hoses or conduits, wherein the plurality of valve banks contain solenoid-controlled dispensing valves.

The valve banks are mounted upon servo devices which are adapted to be moved along a plurality of horizontally oriented, vertically spaced guide rods which are disposed above underlying food product conveyors wherein the vertically spaced guide rods, and the valve banks mounted thereon, extend in directions which are perpendicular to the directional movement of the underlying food product conveyors which convey the food items or products onto which the particular sauces from the sauce containers are to be dispensed and deposited. In this manner, the valve banks can be moved in a direction that is perpendicular to the movement of the product conveyors disposed beneath the valve banks such that the valve banks effectively move in a direction that transversely crosses the food product conveyors disposed beneath the valve banks. Therefore, it can readily be appreciated that, assuming that the food product conveyors are moving in the “x” direction, and that the valve banks are moving in the “y” direction along their guide rods, a valve bank, which includes a plurality of sauce dispensing valves which will respectively permit the sauce from any particular container to be deposited onto any particular food product being conveyed along the food product conveyor, will be capable of effectively being positioned at any “xy” coordinate relative to a particular food product being conveyed along the food product conveyor, at any moment in time, whereby a particular sauce from a particular valve of the valve bank can in fact be deposited onto a particular food product at any time, at any location, and in a variety of modes so as to form, for example, different geometrical shapes or configurations.

Lastly, the automatic sauce dispensing system includes a self-cleaning system which cleans the canisters, the conduits or hoses, and the valves disposed within the valve banks such that food preparation personnel do not have to be involved in the cleaning of the system which is automatically rendered clean at specified intervals such that the sauces being dispensed are always fresh and do not become contaminated. The cleaning system comprises a source of hot water, a source of cleaning fluid, a pump for pumping the cleaning fluid through the system, and a cleaning fluid supply hose which is adapted to be connected to the removable canister caps in lieu of the pneumatic air fittings. The entire automatic sauce dispensing system is also under the control of a suitable automatic control system, such as, for example, a programmable logic controller or PLC.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a schematic view of the new and improved automatic sauce dispensing system as developed by means of the principles and teachings of the present invention and shown incorporated within an automated food preparation line;

FIG. 2 is a schematic view of the new and improved automatic sauce dispensing system as developed by means of the principles and teachings of the present invention and shown as a modular unit that can be inserted into and removed from different automated food preparation lines;

FIG. 3 is an enlarged view of the new and improved automatic sauce dispensing system as developed by means of the principles and teachings of the present invention and wherein the plurality of canister/sauce container assemblies are adapted to be mounted upon its mounting plate and have removable canister caps and quick disconnect fittings which are respectively adapted to be connected to a source of air or pneumatic pressure and to fluid conduits or hoses leading to valve banks comprising the solenoid-controlled dispensing valves for dispensing the particular sauces;

FIG. 4 is an enlarged schematic cross-sectional view of one of the canister/sauce container assemblies disclosing the outer canister, the inner sauce container, the upper removable canister cap, and the lower quick disconnect fitting;

FIG. 5 is a schematic side elevational view of one of the canister/sauce container assemblies as mounted upon its pivotable mounting brackets such that the canister/sauce container assembly can be moved between its upper and lower positions;

FIG. 6 is a perspective view of a plurality of canister/sauce container assemblies as mounted upon the automatic sauce dispensing system network wherein it can be appreciated how the plurality of canister/sauce container assemblies are operatively connected to the pair of valve banks containing the plurality of sauce dispensing valves, and how the pair of valve banks, containing the plurality of sauce dispensing valves, are operatively connected to their servo motors for moving the pair of valve banks along their guides in a direction transverse to or across the directional movement of the food product conveyors disposed beneath the pair of valve banks;

FIG. 7 is a schematic perspective view of a pinch valve assembly which is one exemplary type of valve that may be utilized within the valve bank and in conjunction with the lower end portion of the fluid conduit fluidically connecting the sauce container to the valve bank so as to permit dispensing of the particular sauce onto a food product or for preventing the dispensing of the particular sauce onto a food product; and

FIG. 8 is a schematic cross-sectional view of the pinch valve disclosed within FIG. 7.

### DETAILED DESCRIPTION OF THE PREFERRED EMBODIMENT

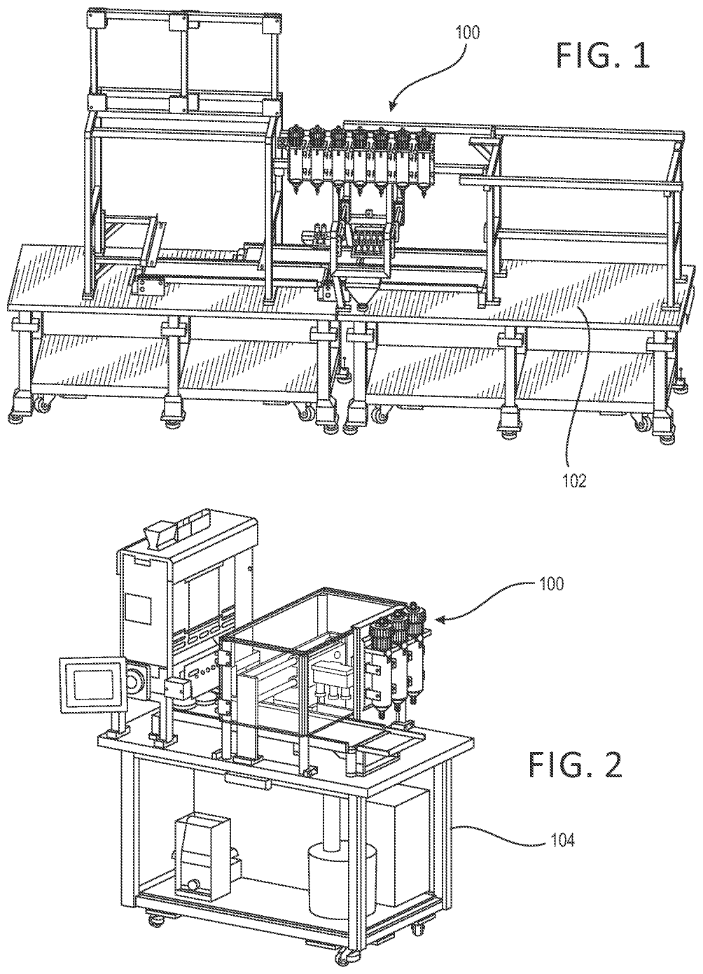

With reference now being made to FIG. 1, the new and improved automatic sauce dispensing system is disclosed and is generally indicated by the reference character 100. As disclosed within FIG. 1, it is to be appreciated that the new and improved automatic sauce dispensing system 100 can be integrally incorporated within an automated food preparation line 102, or alternatively, as disclosed within FIG. 2, the new and improved can effectively be incorporation within a modular system 104 wherein the modular system 104 can be removably inserted into or removed from various different food preparation lines in accordance with the particular requirements of a particular food establishment.

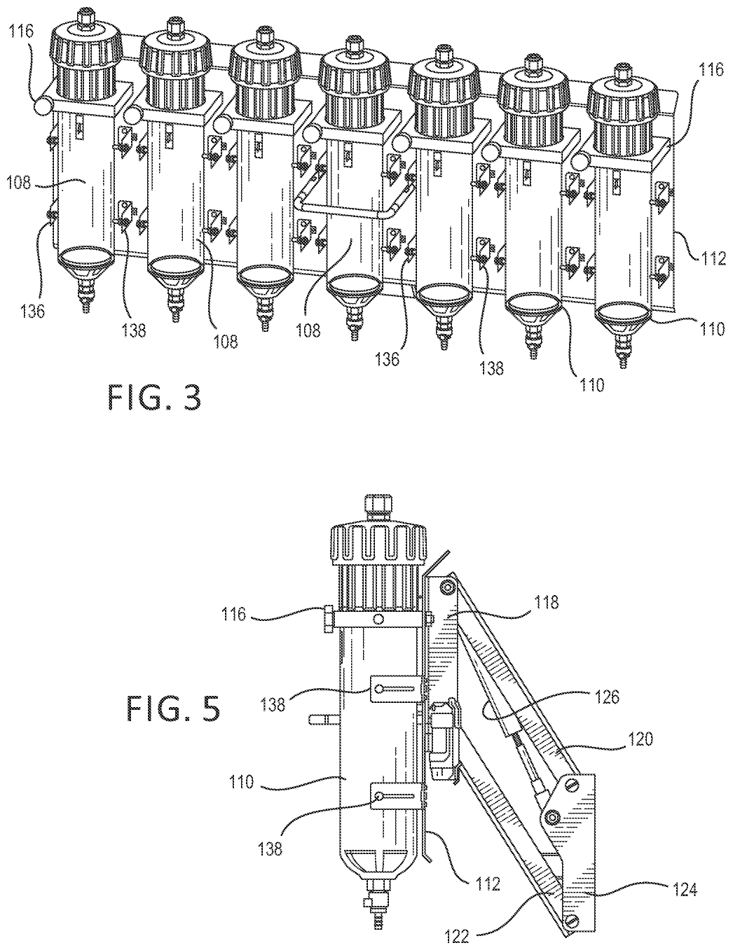

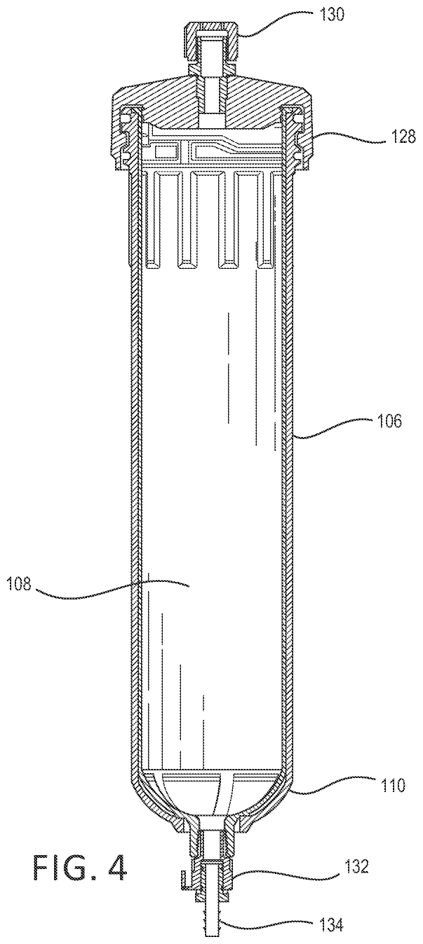

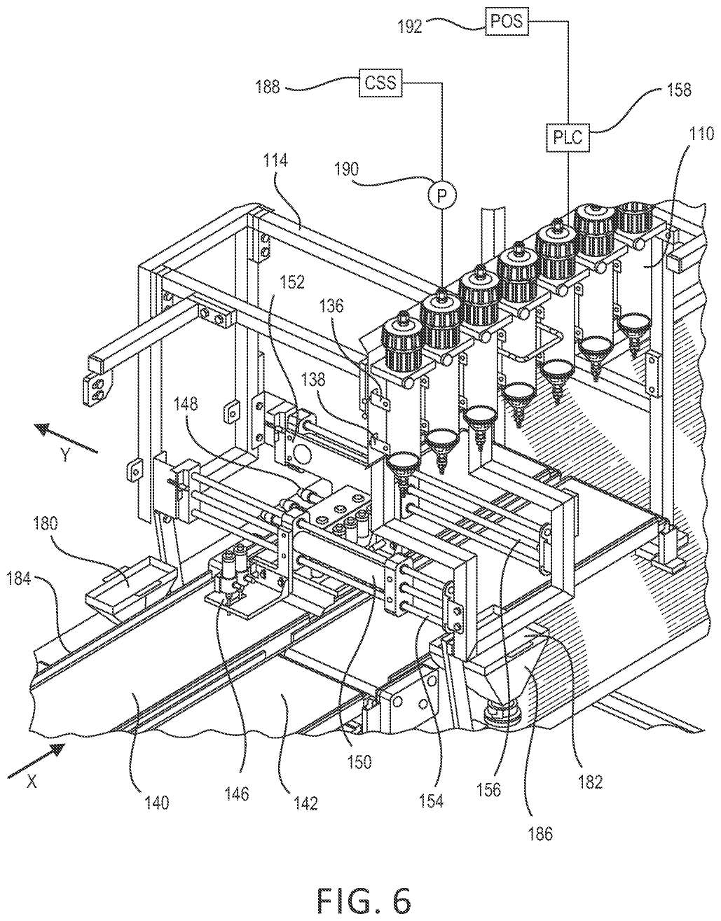

With reference now being made to FIGS. 3 and 4, it is seen that the new and improved automatic sauce dispensing system 100 comprises a plurality of vertically oriented sauce dispensing canisters 106 respectively having sauce dispensing containers 108 removably disposed therein so as to effectively form canister/sauce container assemblies 110. It is seen that the plurality of canister/sauce container assemblies 110 are fixedly mounted in a side-by-side manner upon a vertically oriented mounting plate 112 which is, in turn, fixedly mounted upon an automatic sauce dispensing system framework 114 as shown in FIG. 6. The canister/sauce container assemblies 110 are adapted to be mounted upon the mounting plate 112 by means of mounting blocks 116, and as can best be seen in FIG. 5, the mounting plate 112 is fixedly mounted upon a vertically oriented mounting bracket 118. The mounting bracket 118 is, in turn, mounted upon distal end portions a pair of pivotable legs or arms 120,122 which have their lower or proximal ends pivotally connected to a fixed actuator bracket 124. An actuator 126, which may be, for example, a pneumatic actuator, has its lower end portion pivotably mounted upon the actuator bracket 124 while its upper end portion is pivotably connected to the upper end portion of the mounting bracket 118. In this manner, depending upon whether or not the actuator 126 is extended or contracted, the canister/sauce dispensing container assemblies 110 will be moved between raised and lowered positions so as to be disposed at upper dispensing positions or locations or at lower positions or locations which will facilitate the exchange of depleted sauce containers 108 with new or fresh sauce containers 108 containing full supplies of the particular sauce which is to be disposed at that particular station of the sauce dispensing system 100.

With reference again being made to FIGS. 3-5, it is further seen that each one of the canister/sauce container assemblies 110 includes an upper removable canister cap 128 which may be attached to the canister 106 by means of any suitable quick disconnect type fastener such as, for example, complementary threads, a quarter turn type fastener, a bayonet type fastener, or the like. In conjunction with the removable canister cap 128, there is also provided a pneumatic air fitting 130 which effectively passes through the removable canister cap 128 so as to be in fluidic communication with the interior of the sauce container 108. In this manner, when the pneumatic air fitting 130 is fluidically connected to a source of pressurized air, not shown, the pressurized air will act upon the sauce contained within the sauce container 108 so as to pressurize the same and thereby cause the same to be dispensed out from the lower end portion of the sauce container 108 through means of a nipple or suitable connector 132 which likewise passes through the lower end portion of the canister 106. Accordingly, when a suitable fluid conduit or hose, also not shown, is connected to the nipple or connector 132 by means of a quick disconnect fitting 134, the sauce from the sauce container 108 will be able to pass out from the sauce container 108 and into the fluid hose or conduit, not shown, so as to be conveyed to a dispensing valve disposed within a valve bank, as will be discussed more fully hereinafter, such that the sauce can in fact be dispensed and deposited onto a food product as will also be more fully discussed and better appreciated hereinafter.

With reference again being made to FIGS. 3 and 5, it is seen that at least one pair of level sensors are respectively employed with each canister/sauce container assembly 110 so as to provide warning signals to food preparation personnel that the volumetric amount of sauce remaining within a particular sauce container 108 has reached a predetermined level. The level sensors comprise, for example, a first light beam transmitter 136 which can, for example, send a light beam through the canister/sauce container assembly 110, and a light beam receiver 138 which is disposed diametrically opposite the light beam transmitter 136 so as to receive the light beam signal from the light beam transmitter 136 which passes through the canister/sauce container assembly 110. One or more sets of light beam transmitters 136 and receivers 138 may be utilized so as to provide food preparation personnel with different alarms or warnings as to how much sauce remains within a particular sauce container 108. For example, as shown in FIGS. 3 and 5, two pairs of light beam transmitters 136 and light beam receivers 138 are being utilized. Therefore, for example, when the level of the sauce remaining within the sauce container 108 reaches the upper pair of level sensors 136,138, an alarm or signal will be transmitted so as to warn food preparation personnel that the particular sauce container 108 will soon need to be replaced. In a similar manner, when the level of the sauce remaining within the sauce container 108 reaches the lower pair of level sensors 136,138, an alarm or signal will be transmitted so as to warn food preparation personnel that the particular sauce container 108 must be replaced in view of the fact that the volumetric amount of sauce contained within the sauce container 108 has been completely depleted and that a new or fresh sauce container 108 must replace the depleted sauce container 108. It is to be noted that the light sensing system is attuned or calibrated in such a manner that the sensor system can determine the difference between a sufficient supply of sauce remaining within the sauce container 108 and a film of sauce which may remain upon interior peripheral wall portions of the sauce container 108 as the sauce container 108 becomes depleted.

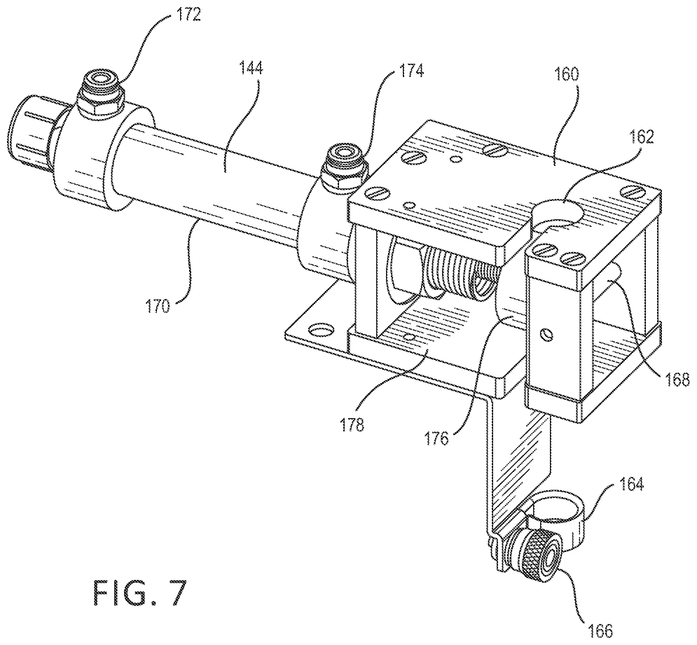

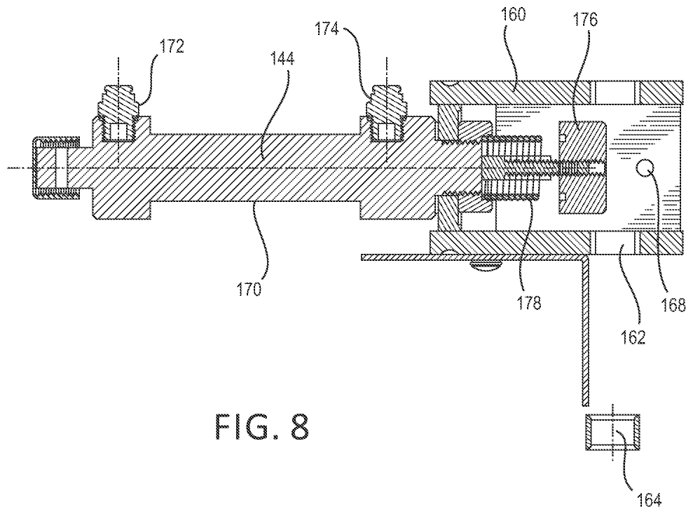

With reference now being made to FIG. 6, it is noted that the number of individual canister/sauce container assemblies 110 may be, for example, seven, however a fewer or greater number of canister/sauce container assemblies may be employed depending upon the particular needs of the particular food establishment. In addition, it is seen that two, side-by-side food product conveyors 140,142 are being utilized to convey food products along the food preparation line, although, again, depending upon the particular needs of the particular food establishment, a fewer or greater number of food product conveyors can be utilized. As has been noted hereinbefore, each one of the sauce containers 108 is adapted to be fluidically connected to a sauce dispensing valve assembly 144, which is more clearly illustrated within FIGS. 7 and 8 and which will be more fully discussed hereinafter, by means of a suitable flexible hose or conduit, not shown. The plurality of sauce dispensing valve assemblies 144 are disposed within two valve banks 146,148 wherein, for example, a first valve bank 146 may house three sauce dispensing valve assemblies 144 which are to be fluidically connected to three of the seven illustrated canister/sauce container assemblies 110, while the second valve bank 148 may house four sauce dispensing valve assemblies 144 so as to be fluidically connected to the remaining four of the seven illustrated canister/sauce container assemblies 110. First and second servo motor drives 150,152 are mounted upon three horizontally oriented, vertically spaced guide rods 154,156, and the valve banks 146,148 are respectively mounted in a dependent manner upon the servo motor drives 150,152 so that as the servo motor drives 150,152 are driven and moved along the guide rods 154,156, the valve banks 146,148 will move correspondingly.

Accordingly, if we consider the food product conveyors 140,142 to be moving in the “x” direction, and since the guide rods 154,156 extend in a direction perpendicular to the “x” direction as a result of the guide rods 154,156 extending transversely across the food product conveyors 140,142 wherein the valve banks 146,148 are disposed above the food product conveyors 140,142 as a result of being suspended from the guide rods 154,156, then the valve banks 146,148, containing the sauce dispensing valve assemblies 144, will effectively be movable in a “y” direction. Therefore, the sauce dispensing valve assemblies 144 can effectively be located at any predetermined “xy” coordinate relative to the food product conveyors 140,142, and relative to any food product located upon the food product conveyors 140,142 as a result of the movement of the food product conveyors 140,142 in the “x” direction and the movement of the valve banks 146,148 in the “y” direction. Accordingly, at any moment in time, a predetermined amount of sauce from a particular sauce dispensing valve assembly 144 of one of the valve banks 146,148 can in fact be deposited onto a particular food product at any time and at any location, and in various manners or modes, as a result of the predeterminediy timed coordination of the movement of the food product conveyors 140,142 and the valve banks 146,148. It is to be noted further that the servo drive motor 150 is mounted upon the guide rods 154 such that the first valve bank 146 is disposed above the first food product conveyor 140 so as to be moved in the “y” direction across the first food product conveyor 140, while in a similar manner, the servo drive motor 152 is mounted upon the guide rods 156 such that the second valve bank 148 is disposed above the second food product conveyor 140 so as to be moved in the “y” direction across the second food product conveyor 142. It is also to be noted that the entire operation of the automatic sauce dispensing system 100, and the various operative components thereof, are under the control of a suitable control system, such as, for example, a programmable logic controller (PLC) 158.

With reference now being made to FIGS. 7 and 8, a description of one of the solenoid-controlled, pneumatically operated sauce dispensing valve assemblies 144 will now be provided. While any of many suitable valve mechanisms may of course be utilized, the sauce dispensing valve assemblies 144 comprise pinch valves type assemblies. More particularly, the valve assembly 144 comprises a housing 160 within which a key-hole shaped slot 162 is provided for permitting the particular sauce hose or conduit, not shown, to be passed therethrough whereby the distal end portion of the hose or conduit will be disposed within an adjustable C-clamp or C-clip 164. A thumb screw 166 is operatively associated with the C-clamp or C-clip 164 such that as the thumb screw 166 is rotated in one direction, the diametrical extent of the C-clamp or C-clip 164 is contracted, thereby tightly engaging the distal end portion of the sauce hose or conduit, while when the thumb screw 166 is rotated in the opposite direction, the diametrical extent of the C-clamp or C-clip 164 is expanded so as to permit release of the sauce hose or conduit. In addition to the foregoing, a horizontally oriented bar 168 is disposed within the housing 160 at a position adjacent to where the sauce hose or conduit passes through the key-hole shaped slot 162 such that the lower distal end thereof is disposed within the C-clamp or C-clip 164. A pneumatic actuator, not shown, is disposed internally within an actuator housing 170, and it is seen that the actuator housing 170 is provided with a pair of pneumatic air inlet/outlet fittings 172,174 disposed at opposite ends of the actuator housing 170. In this manner, when, for example, air is introduced into the air inlet fitting 172, the actuator, disposed internally within the actuator housing 170, will be forced to move toward the right as viewed within FIGS. 7 and 8, thereby causing a plunger or actuator head 176, fixedly mounted upon the distal end of the actuator, to be moved toward the right and into contact with the transversely oriented bar 168 so as to thereby pinch the sauce hose or conduit to a closed position, thereby terminating any dispensing of the sauce from the sauce hose or conduit. As the actuator is moved within the actuator housing 170, air disposed in front of the actuator disposed within the actuator housing 170 will of course be expelled through means of the outlet fitting 174. Conversely, when air is admitted into the air inlet fitting 174, the actuator head 176 will be retracted toward the left so as to effectively relieve the pinching of the sauce hose or conduit, thereby permitting sauce to be dispensed from the sauce dispensing valve assembly 144. While the actuator is being moved toward the left, air behind the actuator will of course be permitted to be expelled or exhausted through means of air outlet fitting 172. It is lastly noted that a coil spring 178 is disposed around the shaft of the actuator so as to normally bias the actuator, and the actuator head 176 toward the right so as to normally maintain the sauce dispensing valve assembly 144 at its closed position. This is to prevent undesirable leakage or dispensing of the sauce in the event that the control air of the pneumatic control system experiences a failure.

Lastly, with reference again being made to FIG. 6, it is seen that the automatic sauce dispensing system also includes a self-cleaning system which cleans the canisters, the conduits or hoses, and the valves disposed within the valve banks such that food preparation personnel do not have to be involved in the cleaning of the system which is automatically rendered clean at specified intervals such that the sauces being dispensed are always fresh and do not become contaminated. More particularly, for example, first and second drip trays 180,182 are disposed along the sides of the food product conveyors 140,142 and are adapted to be linearly aligned with the first and second valve banks 146,148 when the first and second valve banks 146,148 are disposed at their end-of-travel positions along their respective guide rods 154,156. In this manner, when the first and second valve banks 146,148 are not effectively being utilized such that the various dispensing valve assemblies 144 are not actually dispensing sauce onto food products, the first and second valve banks 146,148 will be respectively disposed above the first and second drip trays 180,182 such that if any residual leakage, dripping, or dropping of sauce from any one of the plurality of dispensing valve assemblies 144 mounted upon either one of the first and second valve banks 146,148 occurs, such leakage, dripping, or dropping of such sauce will be caught by means of the first and second drip trays 180,182.

Continuing further, it is also seen that the first and second drip trays 180,182 are adapted to be removably mounted atop first and second cleaning funnels or drains 184,186. As has been previously noted, the automatic sauce dispensing system 100 of the present invention includes an automatic cleaning system wherein the first and second funnels or drains 184,186 are component parts of such automatic cleaning system. More particularly, when it is desired to clean the automatic sauce dispensing system 100, the first and second drip trays 180,182 are removed from the first and second cleaning funnels or drains 184,186, the pneumatic air lines are disconnected from the pneumatic air fittings 130 provided at the upper end of each canister/sauce container assembly 110, and cleaning solution tubes, hoses, conduits, or the like, not shown, are fluidically connected to such fittings 130. A cleaning solution supply CSS is generally indicated at 188 so as to contain a supply of cleaning solution which may comprise, for example, a suitable cleaning solution, a de-greaser or sanitizer, and heated water with enhances the de-greasing or sanitizing agents within the solution, and a pump P, generally indicated by the reference character 190, is interposed fluidically between the cleaning solution supply 188 so as to pump the cleaning solution into the canister/sauce container assemblies 110 through means of the fittings 130. The cleaning solution will then flow through the cleaning solution hoses or conduits, not shown, through the sauce containers 108, and through the conduits or hoses, also not shown, fluidically connecting the canister/sauce container assemblies 110 to the valve banks 146,148, and through the valve mechanisms 144 of the valve banks 146,148 such that the cleaning solution can then exit the valve banks 146,148 and be discarded into the cleaning funnels or drains 184,186.

Obviously, many variations and modifications of the present invention are possible in light of the above teachings. For example, while it has been noted that each canister/sauce container assembly 110 has been fluidically connected to a single dispensing valve assembly 144 through means of its dedicated fluid hose or conduit, more than one fluid hose or conduit maybe connected to a particular dispensing valve assembly 144 so that the volumetric output of that particular dispensing valve assembly 144 may be increased as may be desired. In a similar manner, while it has been noted that each canister/sauce container assembly 110 will contain a particular sauce or condiment such as, for example, mustard, ketchup, or the like, two hoses or conduits, carrying different sauces, may likewise effectively be fluidically connected together at a particular dispensing valve assembly 144 such that a combination of sauces is simultaneously dispensed onto a particular food product. In addition, the sauce containers can be pre-heated or pre-cooled. In this manner, for example, if cheese is to be deposited onto nacho food products, patrons may prefer that the cheese is warmed or heated to above ambient or room temperature. Still further, a user interface, including various selector buttons or touch-screen icons, not shown, may be provided at the patron point-of-sale (POS) location 192 such that the patron can order his or her food item as he or she desires. In addition, the automatic cleaning system may also be initiated from the point of sale (POS) location or from an alternatively located user interface location. It is therefore to be understood that within the scope of the appended claims, the present invention may be practiced otherwise than as specifically described herein.

### REFERENCE NUMBER KEY

100—Automatic sauce dispensing system
102—Automated food preparation line
104—Modular automatic sauce dispensing system
106—Canister
108—Sauce container
110—Canister/sauce container assembly
112—Mounting plate for canister/sauce container assemblies 110
114—Automatic sauce dispensing system framework
116—Mounting blocks for canister/sauce container assemblies upon plate 112
118—Vertically oriented mounting block for mounting plate 112
120,122—Movable arms/legs connecting mounting plate 118 to bracket 124
124—Actuator bracket
126—Actuator
128—Removable canister cap
130—Pneumatic air fitting
132—Dispensing nipple of sauce container 108
134—Quick disconnect fitting for attaching fluid hoses/conduits to nipples 132
136—Level sensor light beam transmitter
138—Level sensor light beam receiver
140,142—First and second food product conveyors
144—Dispensing valve assembly
146,148—First and second valve banks containing dispensing valves 144
150,152—First and second servo motor drives for valve banks 146,148
154,156—First and second guide rods for mounting servo motor drives 150,152
158—Programmable logic controller (PLC)
160—Housing of dispensing valve assembly 144
162—Key-hole shaped slot for accommodating hose/conduit
164—C-clip for end of hose/conduit from sauce container
166—Thumb screw operatively associated with C-clip 164
168—Cross-bar within dispensing valve assembly
170—Actuator housing for dispensing valve assembly
172,174—Pneumatic air fittings for actuator housing 170
176—Actuator head for cooperating with cross-bar to pinch sauce conduit
178—Coil spring operatively associated with actuator 170
180,182—First and second drip trays
184,186—First and second cleaning drain funnels
188—Cleaning solution supply
190—Pump for pumping cleaning solution supply into system for cleaning
192—Point of sale (POS) location

What is claimed as new and desired to be protected by Letters Patent, is:

1. An automatic sauce dispensing system for automatically dispensing sauces onto food products being conveyed along at least one food product conveyor, comprising:
a plurality of sauce containers respectively containing a plurality of sauces;
a plurality of dispensing valves fluidically connected respectively to said plurality of containers containing the plurality of sauces for respectively controlling the dispensing of the plurality of sauces from said plurality of canisters; and
a control system for moving said plurality of dispensing valves relative to the at least one food product conveyor, and for controlling the operation of said plurality of dispensing valves, such that one or more sauces can be dispensed onto particular food products conveyed along the at least one food product conveyor.

2. The system as set forth in claim 1, wherein:
the at least one food product conveyor conveys the food products in a first x direction; and
said control system moves said plurality of dispensing valves in a second y direction which is perpeniduclar to said first x direction such that said plurality of dispensing valves can effectively be disposed at any xy coordinate location relative to the at least one food product conveyor so as to be capable of accurately depositing the sauces on the food products being conveyed by the at least one food product conveyor.

3. The system as set forth in claim 2, wherein:
said plurality of dispensing valves are mounted upon at least one valve bank.

4. The system as set forth in claim 3, further comprising:
at least one guide rod extending across the at least one food product conveyor so as to extend in said y direction;
a servo motor drive movably mounted upon said at least one guide rod; and
said at least one valve bank, having said plurality of dispensing valves mounted thereon, is mounted upon said servo motor drive so that as said servo motor drive moves along said at least one guide rod, said at least one valve bank, having said plurality of dispensing valves mounted thereon, moves along said at least one guide rod in said y direction relative to the at least one food product conveyor.

5. The system as set forth in claim 1, wherein:
said plurality of sauce containers are respectively mounted internally within a plurality of canisters.

6. The system as set forth in claim 5, wherein:
each one of said plurality of canisters is provided with a removable cap so as to permit said sauce container disposed within said canister to be removed from said canister when the supply of sauce contained within said sauce container is depleted, and to permit said depleted sauce container to be replaced by a sauce container containing a full supply of sauce.

7. The system as set forth in claim 6, wherein:
each one of said plurality of end caps for said plurality of canisters is provided with a pneumatic fitting for permitting a supply of pressurized air to be fluidically connected to each one of said plurality of canisters, and to each one of said plurality of sauce containers disposed within said plurality of canisters, so as to pressurize the sauce contained within said plurality of sauce containers.

8. The sauce dispensing system as set forth in claim 5, further comprising:
a sensor system respectively associated with each one of said plurality of sauce containers for sensing the amount of sauce remaining within each one of said plurality of sauce containers so as to enable food preparation personnel to replace a depleted sauce container with another sauce container which has a full supply of sauce contained therein.

9. The system as set forth in claim 8, wherein:
said sensor system respectively associated with each one of said plurality of sauce containers comprises a light transmitter disposed upon one side of a sauce container and a light receiver disposed upon the opposite side of the sauce container,
whereby when a light beam from said light transmitter is received by said light receiver, a warning/alarm will be emitted indicating to food preparation personnel that the sauce supply within the sauce container is being depleted or has been depleted.

10. The system as set forth in claim 9, wherein:
said sensor system is calibrated so as to distinguish between a predetermined volumetric amount of sauce contained within said sauce container and a film of sauce which may be residually disposed upon an internal peripheral wall surface of said sauce container as sauce is depleted from said sauce container.

11. The system as set forth in claim 1, wherein:
each one of said sauce dispensing valves comprises a pinch valve for pinching closed a fluid hose or conduit fluidically connecting a respective one of said plurality of sauce containers to a respective one of said plurality of sauce dispensing valves.

12. The system as set forth in claim 1, wherein:
said control system comprises a programmable logic controller (PLC).

13. The system as set forth in claim 12, further comprising:
a point of sale (POS) location operatively connected to said programmable logic controller (PLC) such that patrons can enter food orders directly into said system.

14. The system as set forth in claim 1, further comprising:
an automatic cleaning system for cleaning said system wherein said cleaning system may be initiated from said point of sale (POS) location and can be controlled by said programmable logic controller (PLC).

15. The system as set forth in claim 1, wherein:
said system comprises an integral component of a food preparation line.

16. The system as set forth in claim 1, wherein:
said system comprises a modular component that can effectively be inserted into and removed from various different food preparation lines.

17. The system as set forth in claim 1, wherein:
at least one of said plurality of sauce containers may be pre-cooled to a temperature below ambient room temperature.

18. The system as set forth in claim 1, wherein:
at least one of said plurality of sauce containers may be pre-heated to a temperature above ambient room temperature.
